(19) United States
(12) Patent Application Publication
(10) Pub. No.: US 2008/0016112 A1
(43) Pub. Date: Jan. 17, 2008

(54) Supporting Multiple Languages in the Operation and Management of a Process Control System

(75) Inventors: Venkateswara K. Reddy, Bangalore (IN); Mohammed Saleem Jahaber, Bangalore (IN); Ravi R. Kumar, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/309,377

(22) Filed: Aug. 2, 2006

Related U.S. Application Data
(60) Provisional application No. 60/767,550, filed on Jul. 7, 2006.

(51) Int. Cl. G06F 17/30

(52) U.S. Cl. 707/104.1; 707/E17.01

(57) ABSTRACT

Supporting multiple languages in the operation and management of a Process Control System. According to one aspect, a user may request a change of language in which a user interface is provided and the data elements in that language are copied from a reference database to a master database. The data required for the user interface is then provided from the master database. Due to the presence of data in multiple languages, the switch from one language to another may be easily accomplished. According to another aspect of the present invention the control strategies in a first language in a first control system can be exported and later imported to control strategies in a second language in a second control system. The reference database in the second control system may be used to translate the elements, while importing the translated control strategies in the master database of the second control system.

### RELATED APPLICATIONS

The present application claims priority from the co-pending U.S. Provisional Patent Application Ser. No. 60/767550, entitled, “Supporting Multiple Languages in the Operation and Management of a Process Control System”, filed Jul. 7, 2006 , attorney docket number: H0012157/HON-024, naming as inventor: Reddy et al, and is incorporated in its entirety herewith.

### BACKGROUND OF THE INVENTION

1. Field of the Invention

The present invention generally relates to process control systems, and more specifically to a method and apparatus for supporting multiple languages in the operation and management of a process control system.

2. Related Art

Process control systems are generally used to control the operation of a number of devices in environments such as manufacturing plants, factories, and oil refineries. Often, a process control system is developed/provided by a vendor (e.g., Honeywell International, Inc., the intended assignee of the subject patent application) and used by organizations (typically owners) having responsibility for the respective environments.

There has been a general recognized need for providing interfaces that are localized (or customized) for each user in the language of the user's choice such that the user can effectively interact with the control system. One common reason for such a requirement is that the operation of a control system is often managed by a large number of users speaking different languages.

Another common reason for such a requirement is a vendor (or the organization) may design control strategies (which control the operation of individual components in the environment sought to be controlled) in one language and convert the strategies to other languages, potentially for use in similar environments in other geographical locations.

Such localized interfaces may need to be provided while meeting various constraints typical of process control systems. For example, it is generally necessary that the operation of the environment not be interrupted while the users switch from one language interface to the other. In addition, it is also generally necessary that the same information be provided continuously with imperceptible degree of interruption when the language interface is switched.

Various aspects of the present invention meet one or more of the requirements noted above.

### SUMMARY OF THE INVENTION

An aspect of the present invention provides an approach to support multiple languages in a control system. In an embodiment, a reference database containing data of interest in each of the languages is maintained. However, when processing commands received from a user, data is returned in a first language from a master database, which stores data in the first language.

When a command to switch to a second language is received, in an embodiment, the data of interest in the second language from the reference database is copied to the master database. From then on, when processing additional commands, data is returned in the second language from the master database in the second language.

To maintain the data of interest in multiple languages in the reference database, in an embodiment, the data of interest may be extracted from the master database in the first language, and translated into other languages of interest. The translated data may be updated in the reference database.

To perform the translation, in an embodiment, a map of elements in the first language to corresponding elements in the second language is received from a user, and each element in the data of interest in the first language is mapped to the corresponding element in the second language according to the map. Thus, the user may conveniently control which all elements are translated into the second language (or all languages of interest). In addition, the approach would not require dynamic machine translation and is thus easier to implement.

According to another aspect of the present invention, when a command is received to switch to a language selected by a user, an indication data indicating the selected language, is stored in a common location. Then various other applications (i.e., user interface provided to other users on other systems) may examine the indication data to determine the specific language to operate in. As a result, all the application may operate in the same language selected by the user. In one embodiment, the common location corresponds to an entry in the master database.

Yet another aspect of the present invention facilitates exporting a data of interest from a first master database (in a first control system) containing data in a first language to a second master database (in a second control system) containing data in a second language. In an embodiment, a reference database containing the data of interest in multiple languages (including the first language and the second language) is maintained in the second control system. The data of interest is extracted from the first master database, and the reference database is examined to determine data in the second language corresponding to the data of interest. The retrieved data in the second language is then stored in the second master database.

The approach of above can be conveniently used to transfer control strategies from the first control system to the second control system.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings briefly described below.

FIG. 1 is a block diagram illustrating an example embodiment in which several aspects of the present invention can be implemented.

FIG. 2 is a flowchart illustrating the manner in which multiple languages are supported in a database according to an aspect of the present invention.

FIG. 3 depicts the data contents of a table in a master database in a first language according to an example convention.

FIG. 4 depicts the contents of a table in a reference database containing data in a second language corresponding to a data of interest in a first language in a master database.

FIG. 5 depicts the data contents of a table in a master database containing data in a second language copied from a reference database corresponding to data of interest in a first language.

FIG. 6 is a flowchart illustrating the manner in which a reference database containing data of interest in multiple languages is maintained according to an aspect of the present invention.

FIG. 7 depicts the contents of a file containing data in multiple languages used for maintaining (updating) a reference database in an example embodiment.

FIG. 8 is a flowchart illustrating the manner in which the language selected by a user is determined by other applications of a process control system according to an aspect of the present invention.

FIG. 9 is a block diagram illustrating an example scenario in which the import and export of data between control systems can be implemented.

FIG. 10 is a flowchart illustrating the manner in which export and import of data representing control strategy between control systems is performed according to an aspect of the present invention.

FIG. 11 depicts an interface using which a user can specify information about a control strategy in a first language in a first control system.

FIG. 12 depicts an interface using which a user can specify information about a control strategy in a second language in a second control system.

FIG. 13 depicts the content of a file (encoded as XML) used to export/import data representing control strategies from one control system to another control system.

FIG. 14 is a block diagram illustrating the details of digital processing system in which various aspects of the present invention are operative by execution of appropriate software instructions.

### DETAILED DESCRIPTION OF THE PREFERRED EMBODIMENTS

Various aspects of the present invention facilitate supporting of multiple languages in the management and operation of process control systems. Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 1. Example Embodiment

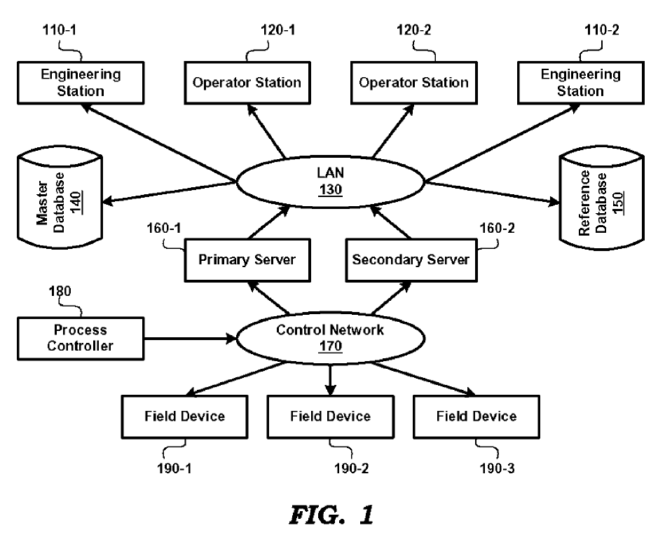

FIG. 1 is a block diagram illustrating an example embodiment in which several aspects of the present invention can be implemented. The embodiment may control various devices (other than field devices, not shown) of an environment of interest. The embodiment is shown containing engineering stations 110-1 and 110-2, operator stations 120-1 and 120-2, LAN (Local Area Network) 130, master database 140, reference database 150, primary server 160-1, secondary server 160-2, control network 170, process controller 180, and field devices 190-1 to 190-3. Each block is described in further detail below.

Control network 170 connects each of primary server 160-1, secondary server 160-2 and process controller 180 with field devices 190-1 to 190-3. Control network 170 may contain network devices (e.g., multiplexors, modems, termination panels, etc.,) operating according to one or more protocols such as HART, Control Net, and Foundation Field Bus well known in the relevant arts.

Process controller 180 issues commands to control the operation of field devices 190-1 to 190-3 to implement a desired control strategy in the environment being controlled. In general, the desired control strategies can be programmed from engineering stations 110-1 and 110-2, and can also be modified in minor respects during operation by operators using operator stations 120-1 and 120-2. Field devices 190-1 to 190-3 perform various operations under the control of process controller 180 to implement desired control strategies.

Primary server 160-1 receives commands from engineering stations 110-1 and 110-2 and operator stations 120-1 and 120-2 related to configuration or monitoring of field device 190-1 to 190-3 and executes the corresponding actions. For example, monitoring a field device may require primary server 160-1 to retrieve the information about the status of the field device using process controller 180 via control network 170, store the information in master database 140 and return the information to the engineering station or operator station that issued the command. The data in master database 140 may also be retrieved and returned to the user application, in response to corresponding command types.

Secondary server 160-2 operates in close association with primary server to provide an alternative to primary server 160-1 in case primary server 160-1 becomes unavailable. In general, one of the two servers 160-1 and 160-2 operates as a primary, and the secondary server takes on the role of the primary when the primary becomes unavailable. The necessary communication between the two servers may be provided either using LAN 130 or by an independent dedicated path (not shown) provided between the two servers.

Therefore, communication is established between primary server 160-1 and secondary server 160-2 such that relevant information (e.g., memory map) is duplicated to secondary server also, so that the switchover is seamlessly performed. In addition, as described below, each client system may be implemented to periodically check which of the server systems is operating as a primary, and send commands to the server presently operating as the primary server. The description is continued with respect to primary server 160-1 merely for illustration though secondary server 160-2 may be substituted in the place of primary server 160-1.

LAN 130 provides communication between engineering station 110-1 and 110-2, operator station 120-1 and 120-2, master database 140, reference database 150, primary server 160-1 and secondary server 160-2 using protocols such as TCP/IP well known in the relevant arts.

Engineering stations 110-1 and 110-2 provide interfaces to configure various control strategies manually, in addition to providing the capability to monitor various field devices. Operator stations 120-1 and 120-2 are used to display the status of the various field devices and may incorporate simple means of input such as providing pre-defined options that can be selected.

In general, client systems (for example, engineering stations and operator stations) provide a user interface using which users may manage (view information or perform configuration of) field devices. A user to effectively manage the field devices may require the user interface to be displayed in the language of the user's choice. Localization of the user interface in client systems may be provided by installation of user interface packs, which provide interface specific language conversions required to switch from one language to another.

Also, as noted above, each client system checks periodically the specific one of the servers 160-1 and 160-2, which is presently operating as a primary server, and sends the commands to that server. The response is received from the primary server (assuming 160-1, in FIG. 1), and displayed using a suitable interface in the language presently selected by the user.

Master database 140 provides a central repository for storing information related to configuration of field devices, status of field devices, maintenance schedules, etc. Generally, the stored information is retrieved and displayed to the user in the user interface provided in the client systems. Localization of the user interface often necessitates the information in master database 140 to be made available in the language of the user's choice in order to be consistent with the user interface. As such, master database 140 provides support for returning data in multiple languages. Various aspects of the present invention enable support of multiple languages in a database using a reference database as described in detail below.

Reference database 150 is used for storing information in multiple languages and is used along with master database 140 by primary server 160-1to provide information to client systems in the language selected by the user. Each of master database 140 and reference database 150 can be implemented using one of several commercially available database servers (such as Microsoft SQL Server 2000 from Microsoft Corporation). In addition, though shown as separate blocks, reference database 150 and master database 140 can be implemented in a single database server. The manner in which a reference database is used to provide support for multiple languages in a database is described below in detail.

II. Supporting Multiple Languages in a Database

II. 1. Flowchart

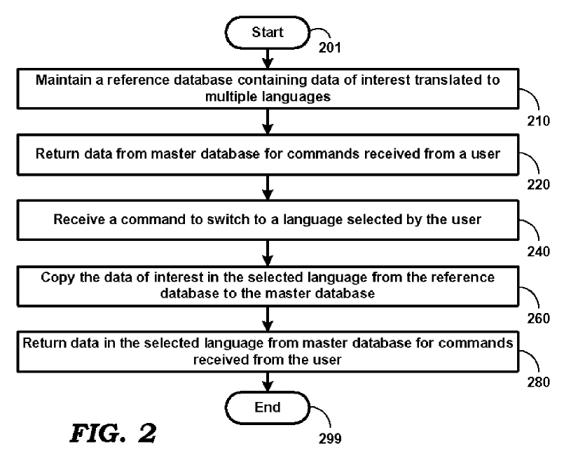

FIG. 2 is a flowchart illustrating the manner in which multiple languages are supported in a database according to an aspect of the present invention. The flowchart is described with respect to FIG. 1 merely for illustration. The features can however be implemented in other environments as well, as will be apparent to one skilled in the relevant arts by reading the disclosure provided herein. The flowchart begins in step 201, wherein control immediately passes to step 210.

In step 210, primary server 160-1 maintains a reference database (reference database 150 in FIG. 1) containing data of interest translated to multiple languages. Alternatively, secondary server 160-2 may be used to maintain reference database 150, in order to reduce the load on primary server 160-1.

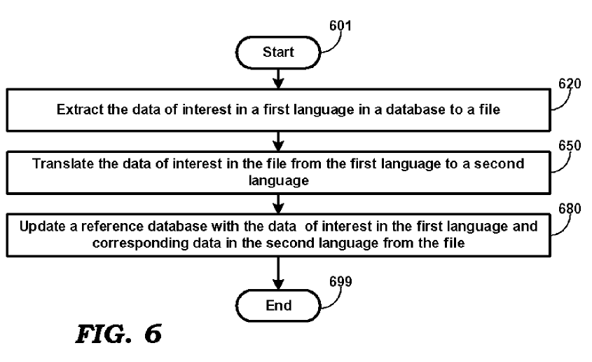

The data of interest refers to data in master database 140 that needs to be provided in the language of a user's choice. Typically data of interest contains textual information that needs to be translated to multiple languages. It may be appreciated that other information such as numeric data or date/time information may not be required to be translated into multiple languages. The manner in which data of interest is maintained in multiple languages in reference database 150 is described in detail with respect to FIG. 6.

In step 220, primary server 160-1 returns data from master database (master database 140 in FIG. 1) for commands received from a user. The commands are received from the client systems, which may provide appropriate user interfaces to the user to issue commands to retrieve data from master database 140, and also to display the results (or data received from primary server 160-1).

In step 240, primary server 160-1 receives a command to switch to a language selected by the user. The languages supported by reference database 150 (that is the languages to which the data of interest has been translated and in which user interface can be provided) are displayed to the user, thereby enabling the user to select the language of the user's choice.

In step 260, primary server 160-1 copies the data of interest in the selected language from the reference database to the master database. It may be appreciated that by copying the data of interest from reference database 150 to master database 140, applications executing in different client systems may store/retrieve information using a single database irrespective of the language selected by the user. Such a feature enables information about the status of field devices to be provided to the client systems with minimal delay during the switching of languages.

In step 280, primary server 160-1 returns data in the selected language from master database for commands received from the user. It may be appreciated that the commands received may be similar to (or same as) the commands received in step 220. Thus, an application executing in engineering station 110-1 may retrieve information from master database 140, using the same commands irrespective of the language selected by the user. The flow chart ends in step 299.

Thus, primary server 160-1 facilitates supporting multiple languages in master database 140 using the translated data of interest stored in reference database 150. The manner in which multiple languages are supported in a database is illustrated below with an example.

II. 2. Illustration

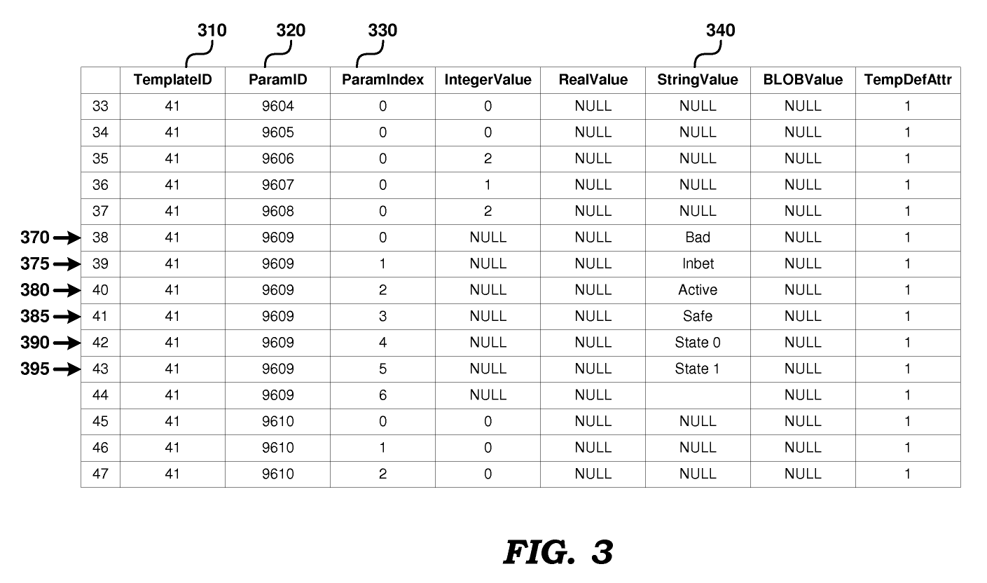

FIGS. 3, 4 and 5 together are used to illustrate the manner in which the approach(es) of FIG. 2 can be used to support multiple languages in a database. Each Figure is described below in further detail.

FIG. 3 depicts the data contents of a table in a master database (master database 140) in a first language (“English”) according to an example convention. 66 Column 340 “StringValue” represents the data of interest, which needs to be provided in multiple languages. Each row in the table (for example, rows 370 to 395) can be uniquely identified using the combined values of column 310 “TemplateID”, column 320 “ParamID” and column 330 “Paramindex”, which form a unique/primary key of the table. It may be noted, that other columns not requiring translation such as “IntegerValue” may be present along with the columns/data of interest.

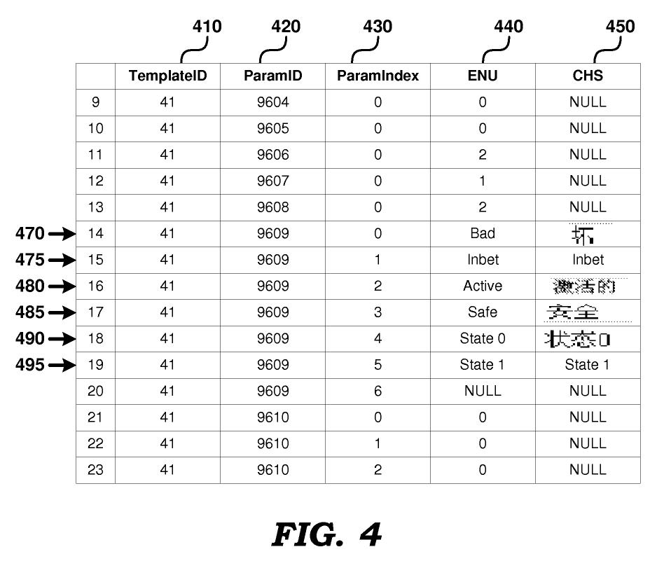

FIG. 4 depicts the contents of a table in a reference database (reference database 150) containing data in a second language (“Chinese”) corresponding to a data of interest in a first language (“English”) in a master database (master database 140).

Column 440 “ENU” (representing “English”) represents the data of interest and is a copy of the data from column 340 present in master database 140. Columns 410, 420 and 430 are also a copy of the columns 310, 320 and 330 present in master database 140 and as such form a unique/primary key for uniquely identifying each row (for example, rows 470 to 495).

Column 450 “CHS” (representing “Chinese”) shows the data of interest translated to a second language (“Chinese”) and corresponds to the data in column 440. Thus, in row 470, the data in column 450 in “Chinese” corresponds to the data “Bad” in column 440 in “English”.

It may be appreciated that more columns may be added to reference database 150, thereby providing support for multiple languages. Primary server 160-1 generates/maintains the data of interest (as shown in FIG. 4) in multiple columns (languages) in reference database 150 as described in detail below with respect to FIG. 6.

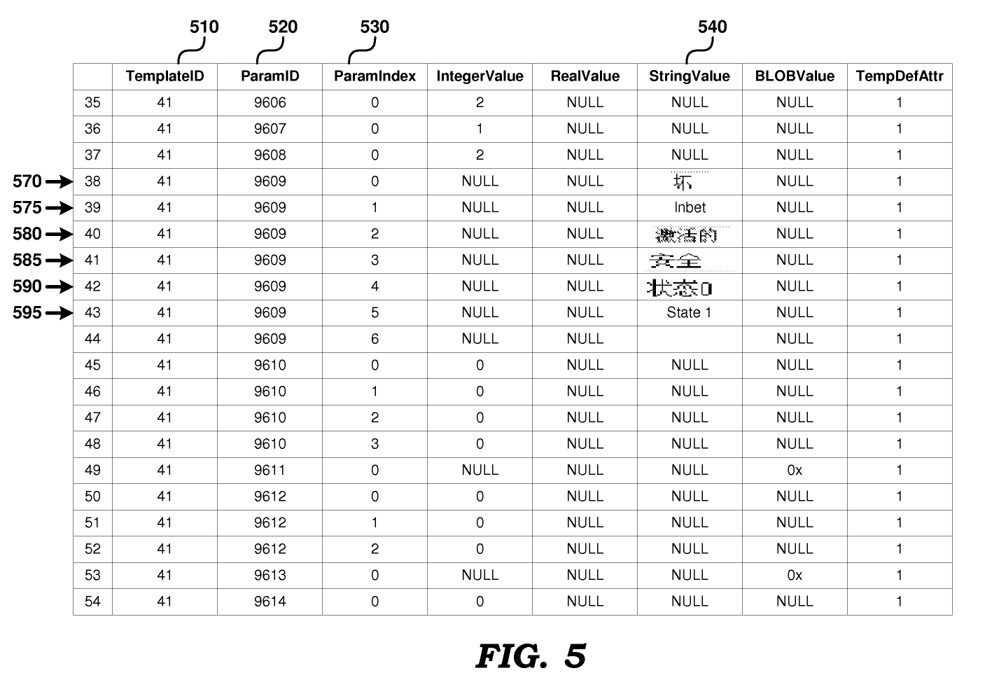

FIG. 5 depicts the data contents of a table in a master database (master database 140) containing data in a second language (“Chinese”) copied from a reference database (reference database 150) corresponding to data of interest in a first language (“English”) (once a user has requested switching to Chinese language).

The table depicted in FIG. 5 corresponds to the table depicted in FIG. 3, with columns 510, 520 and 530 corresponding to columns 310, 320 and 330 thereby forming a unique/primary key. Column 540 corresponds to data copied from column 450 of reference database 150. Primary server 160-1 copies the data from column 450 to column 540 using the unique/primary key (the combined value of 510, 520 and 530).

It may be noted that the data of interest (column 340) in a first language (“English”) depicted in rows 370 to 395 have been replaced with corresponding data in a second language “Chinese” as depicted in column 540 of rows 570 to 595.

The manner in which primary server 160-1 provides support of multiple languages in a database by using the translated data maintained in a reference database is described in detail below.

II. 3. Maintaining a Reference Database

FIG. 6 is a flowchart illustrating the manner in which a reference database containing data of interest in multiple languages is maintained according to an aspect of the present invention. The flowchart is described with respect to FIG. 1 merely for illustration. The features can however be implemented in other environments as well, as will be apparent to one skilled in the relevant arts by reading the disclosure provided herein. The flowchart begins in step 601, wherein control immediately passes to step 620.

In step 620, primary server 160-1 extracts the data of interest in a first language (“English”) in a database (master database 140) to a file. The data of interest may be specified using the rows and columns of a table in master database 140. For example, column 340 of rows 380, 385 and 390 may be used to specify the data of interest “Active”, “Safe” and “State0” with respect to the table depicted in FIG. 3.

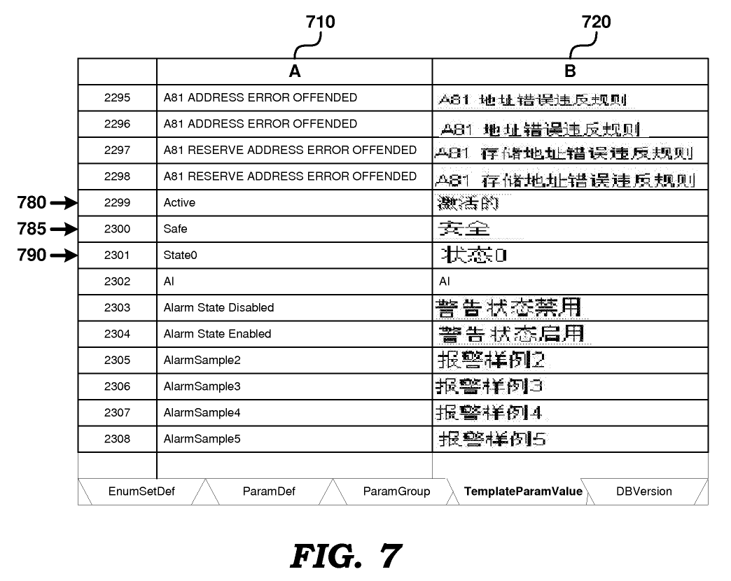

In step 650, primary server 160-1 translates the data of interest in the file from the first language (“English”) to a second language (“Chinese”). In an example embodiment described below with reference to FIG. 7, a mapping file containing the translated data for the data of interest is maintained, and translations are performed using the mapping file. The mapping file can be generated manually. Alternatively, a machine-based translator may be used to effect the translation.

FIG. 7 depicts the contents of a file containing data in multiple languages used for maintaining (updating) a reference database in an example embodiment. Column 710 contains the data of interest in the first language that has been copied from master database 140. Column 710 of rows 780, 785 and 790 depict the data of interest “Active”, “Safe” and “State0” that have been copied from column 340 of rows 380, 385 and 390.

Column 720 contains data in a second language corresponding to data of interest. Column 720 rows 780, 785 and 790 depict the data corresponding to data of interest depicted in column 710. It may be appreciated that more columns may be provided to enable translation of the same data of interest into multiple languages (one language per column).

Continuing with reference to FIG. 6, in step 680, primary server 160-1 updates a reference database (reference database 150) with the data of interest in the first language and corresponding data in the second language. The updating of the data of interest in the first language may not be required, as it may have been copied directly from the database (master database 140). The flowchart ends in step 699.

Thus, by using the data in the master database, the data of interest may be provided for displaying in a language a user has earlier selected. The remaining portion of display screens may also be provided in the same language (e.g., using language specific DLLs in the case of Microsoft's Windows Operating system) using various techniques well known in the relevant arts. The description is continued with respect to the manner in which the change of language can affect other applications of the process control system.

III. Localization of Applications

III. 1. Introduction

Process control systems typically contain several applications running in various systems like operator stations, engineering stations, help desks, and databases. The selection of a language by a user of one of the applications may require the other applications to switch to the selected language in order to provide a consistent user interface for the whole process control system. This is typically required in the scenario where a user sends a command to switch to a new language to a database, thereby necessitating the applications using the data in the database to switch to the new language. The manner in which such a feature is attained according to an aspect of the present invention is described below.

III. 2. Flowchart

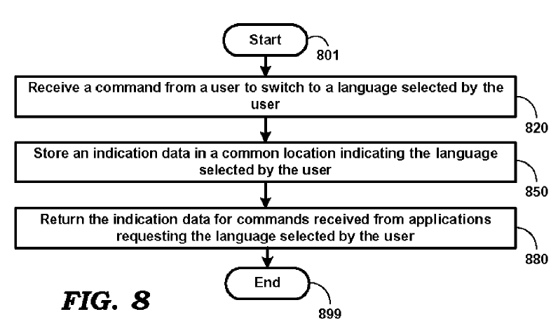

FIG. 8 is a flowchart illustrating the manner in which the language selected by a user is determined by other applications of a process control system according to an aspect of the present invention. The flowchart is described with respect to FIG. 1 merely for illustration. The features can however be implemented in other environments as well, as will be apparent to one skilled in the relevant arts by reading the disclosure provided herein. The flowchart begins in step 801, wherein control immediately passes to step 820.

In step 820, primary server 160-1 receives a command from a user to switch to a language selected by the user. Typically, the languages that are supported by all the application running in a process control system are displayed to the user, thereby enabling the user to select the language of the user's choice.

In step 850, primary server 160-1 stores an indication data in a common location indicating the language selected by the user. In an embodiment, the indication data is stored in master database 140 according to a pre-specified convention (which permit retrieval by an appropriate identifier). In step 880, primary server 160-1 returns the indication data for commands received from applications requesting the language selected by the user. The flow chart ends in step 899.

It may be appreciated that various applications of a process control system may determine the language selected by the user by sending an appropriate command to primary server 160-1. The applications may then operate in (or provide user interface in) that language. In an embodiment, each application checks the common location only once at the time of initialization (of the application). In such an embodiment, when the user of another application changes the language, the application may need to be reinitialized to switch to the new language completely.

The description is continued with respect to exporting control strategies from one process control system to another.

IV. Export/Import of Values Used in Control Strategies

IV. 1. Introduction

A common scenario in process control systems is that the same organizations (owners) of a process control system may have multiple installations of the same or similar environment (for example, manufacturing plants) in different geographical locations. Thus, the operation of the process control systems controlling the two environments would require similar control strategies to be implemented in different languages.

It would be desirable for control strategies specified/stored in one language to be made available for further refinement in other languages. One of the challenges in transferring the control strategies to new control systems is the transfer of values (particularly textual information) used in the control strategies, particularly when the languages of the control systems differ. Often the control strategies contain fields, with each field having a value associated with a pre-defined name. It is desirable that the values be accurately transferred associated with the name for each field in the control strategy.

An aspect of the present invention enables the export/import of such values from a first control system in one language to a second control system in another language, as described below in further detail.

IV. 2. Example Scenario

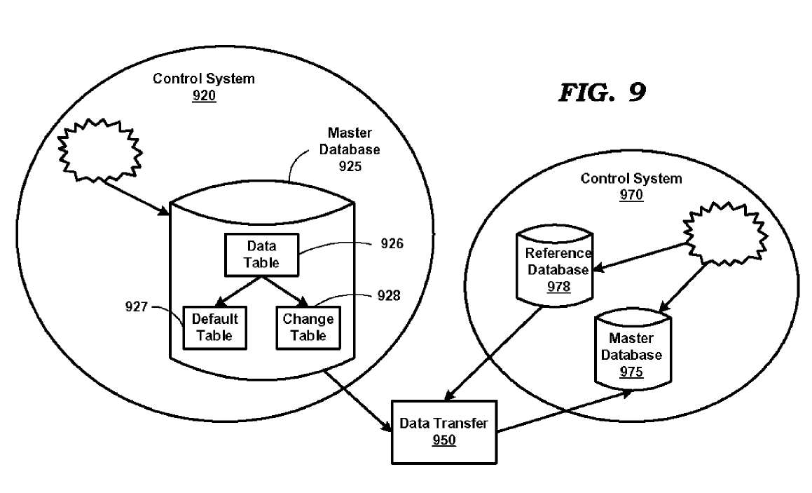

FIG. 9 is a block diagram illustrating an example scenario in which the export and import of values used in control strategies between control systems can be implemented. The block diagram depicts the details of control system 920 containing master database 925 (containing data table 926, default table 927 and change table 928), and control system 970 containing master database 975 and reference database 978, and data transfer 950. Each system is described in further detail below.

Control systems 920 and 970 are each similar to that described in the example embodiment of FIG. 1. Control system 920 represents the first control systems from which control strategies need to be transferred to the second control system (control system 970).

Master databases 925 and 975 are similar to master database 140 and reference database 978 is similar to reference database 150. Master database 925 contains the control strategies specified in a first language (say English) that needs to be transferred to master database 975, which is localized in a second language (say Chinese).

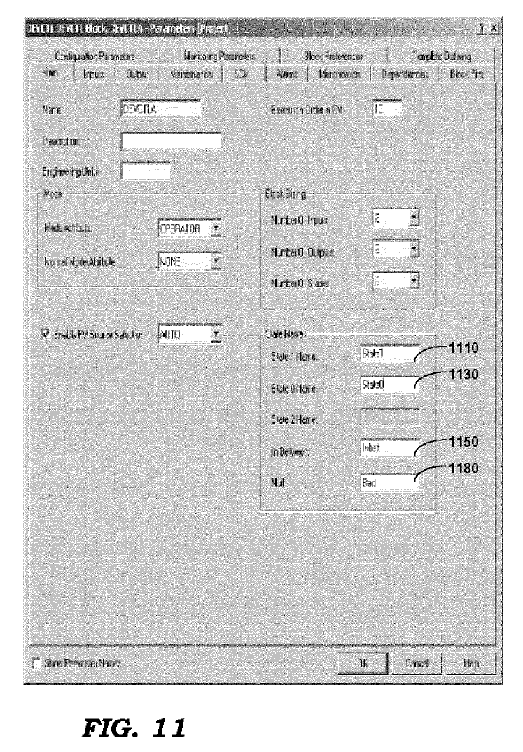

Data table 926 contains some of the values used in control strategies (for example, the control strategy depicted in FIG. 11) and is used to control the operation of the field devices. Each row in data table 926 represents a field, with the data in column(s) representing the value(s) associated with the field. Though only a single data table is shown, a control system may contain multiple data tables, with each table containing the values of multiple strategies. Similarly, it may be appreciated that a field may be represented using multiple rows in different data tables.

Default table 927 contains the default values for each of the fields of the control strategy and represents the pre-defined values (set possibly by the vendor or an external support organization in the control system) for each of the fields of the control strategy.

Change table 928 stores the values of each field of a control strategy, as a user specifies new values. When new values used in a control strategy are stored in data table 926, the new values are compared to the default values stored in default table 927. In the scenario, where the values are different from the default values, change table 928 is updated with the new user specified values.

Thus, change table 928 and default table 927 enable an audit trail (recording the user specified changes) to be maintained for data table 926. In an embodiment, for each instance of data table for which audit trail information needs to be maintained, a corresponding pair of default table and change table is maintained.

Master database 975 also contains tables (not shown) similar to data table 926, default table 927 and change table 928, but for control system 970. Values used in control strategies need to be transferred from one data table in a first language (in master database 925) to another data table in a second language (in master database 975).

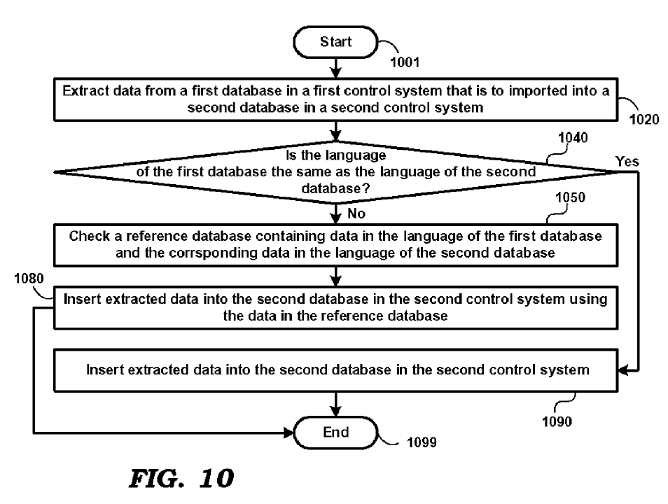

In one embodiment, the values (in the first language) that are inserted in the data table are compared to the values in the default table (in the second language), thereby causing a update to the change table even when the inserted values and the default values are the same (though represented in different languages). Such an update is prevented due to an aspect of the present invention, as described below with respect to FIG. 10.

Data transfer 950 exports values used in control strategies from master database 925 in the first language and imports the values in a second language into master database 975. The manner in which the values used in control strategies are transferred from the first control system to the second control system is described in detail below.

IV. 3. Flowchart

FIG. 10 is a flowchart illustrating the manner in which export and import of values used in control strategy between control systems is performed according to an aspect of the present invention. The flowchart is described with respect to FIG. 9 merely for illustration. The features can however be implemented in other environments as well, as will be apparent to one skilled in the relevant arts by reading the disclosure provided herein. The flowchart begins in step 1001, wherein control immediately passes to step 1020.

In step 1020, data transfer 950 extracts data from a first database (master database 925) in a first control system (control system 920) that is to be imported into a second database (master database 975) in a second control system (control system 970). In the embodiment described below, the extracted data containing the values is stored in a file encoded in extended markup language (XML).

In step 1040, data transfer 950 checks whether the language of the first database is the same as the language of the second database. Control passes to step 1090 if the languages are the same or to step 1050 otherwise. In step 1090, data transfer 950 inserts the extracted data into the second database in the second control system.

In step 1050, data transfer 950 checks a reference database (reference database 978) containing data in the language of the first database and the corresponding data in the language of the second database. It may be appreciated that in FIG. 9 though the reference database is depicted as contained in the second control system, it may be present independently or may be contained in the first control system.

In step 1080, data transfer 950 inserts extracted data into (the data table of the master database) the second control system using the data in the reference database (to convert data from the language of the first database to the language of the second database). The flowchart ends in step 1099.

It should be appreciated that by converting the data (containing values used in a control strategy) from the (first) language of the first database to the (second) language of the second database, the default values are also converted before insertion in a data table in the second database. Since, the converted default values (in the second language) are same as the default values (in the second language) stored in the default table associated to the data table, the change table associated to the data table is not updated. Thus, the audit trail for values in the data table is properly maintained using the associated default table and change table.

Thus, data transfer 950 facilitates the export/import of data containing values used in control strategies from a first control system to a second control system using a reference database. The manner in which a reference database is used to facilitate export/import of control strategy is illustrated below with an example.

IV. 4. Illustration

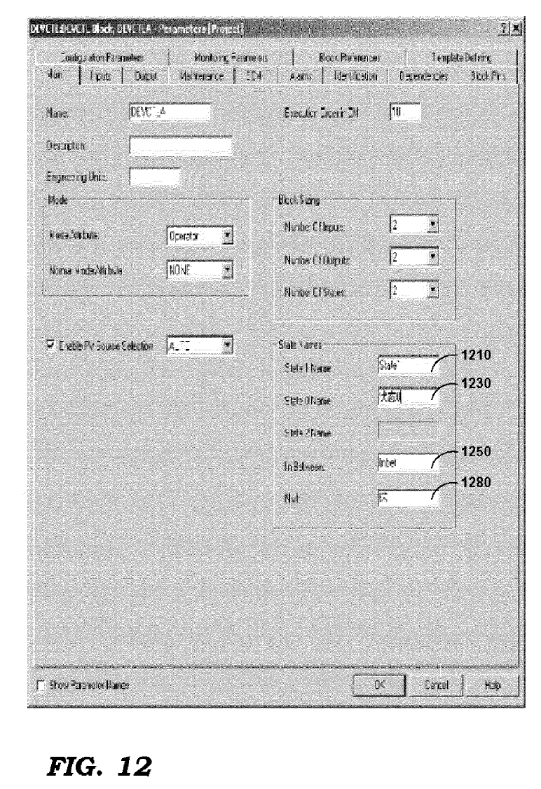

FIGS. 11, 12, 13 (along with FIGS. 3, 4 and 5) together are used to illustrate the manner in which the approach(es) of FIG. 10 can be used to export/import control strategies from one control system to another. The illustration is provided in a scenario in which the first master database (from which data is to be exported) has values in English (as illustrated below with reference to FIG. 11) and the second master database (into which data is to be imported) has values in Chinese (as illustrated below with reference to FIG. 12). Each Figure is described below in further detail.

FIG. 11 depicts an interface using which a user can view a control strategy in a first language (“English”) in a first control system. Textboxes 1110, 1130, 1150 and 1180 are provided for a user to view values corresponding to various fields (e.g., textbox 1110 displaying the value of field “State1 Name”) displayed in a first language (“English”) used in a control strategy. The information displayed in the text boxes may be retrieved from a database (master database 925) where the information may be stored in the form of a table depicted in FIG. 3. The data of textboxes 1110, 1130, 1150 and 1180 corresponds to column 340 of rows 395, 390, 375 and 370. It may be appreciated that the user may specify new values or alter existing values used in a control strategy and the table (depicted in FIG. 3) may be updated with the user specified values.

FIG. 12 depicts an interface using which a user can view a control strategy in a second language (“Chinese”) in a second control system. Textboxes 1210, 1230, 1250 and 1280 are provided for a user to view values in a second language (“Chinese”), and correspond to the values in the first language specified in textboxes 1110, 1130, 1150 and 1180. The information displayed in the textboxes may be retrieved from a database (master database 975) where the information may be stored in the form of the table depicted in FIG. 5. The data of textboxes 1210, 1230, 1250 and 1280 corresponds to data in column 540 of rows 595, 590, 575 and 570.

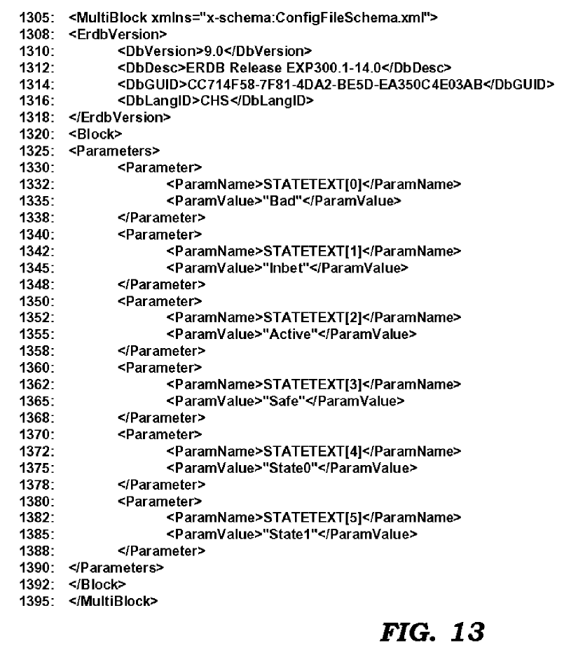

FIG. 13 depicts the content of a file (encoded as XML, described in further detail in a book entitled “XML in a Nutshell, Third Edition” by Elliotte Rusty Harold and W. Scott Means, published by O'Reilly with ISBN 0-596-00764-7) used to export/import data representing control strategies from one control system to another control system.

Lines 1305 to 1395 (“<MultiBlock> . . . </MultiBlock>”) specify the data that is generated by data transfer 950 by exporting (extracting) the information about control strategies (for example, the values used in a control strategy as depicted in FIG. 11) from a first database (master database 925) in a first control system (control system 920).

Lines 1308 to 1318 (“<ErdbVersion> . . . </ErdbVersion>”) specify the information about the version of a second database (master database 975) in a second control system (control system 970) into which the data is to be imported. In particular, line 1316 (“DbLangID> . . . </DbLangID>”) specifies the language “CHS” (“Chinese”) of the second control system.

Lines 1325 to 1390 (“<Parameters> . . . </Parameters>”) specify the fields contained in a control strategy (as depicted in FIG. 11). Lines 1380 to 1388 (“<Parameter> . . . </Parameter>”) specify a single field that contains the value “State1” as depicted in line 1385 (“<ParamValue> . . . </ParamValue>”) displayed to a user in textbox 1110. Similarly, lines 1370 to 1378, 1340 to 1348, and 1330 to 1338 correspond to data displayed to the user in text boxes 1130, 1150 and 1180 respectively.

Data transfer 950 after extracting the data (depicted in FIG. 13) from the first control system, in step 1050, checks for a reference database (reference database 978) containing data in the first language (“English”) and the corresponding data in the second language (“Chinese”). Reference database 978 may contain relevant data in the form of the table depicted in FIG. 4. Lines 1380 to 1388, 1370 to 1378, 1340 to 1348, and 1330 to 1338 in the exported file corresponds to the data in column 440 of rows 495, 490, 475 and 470. The corresponding data in the second language (“Chinese”) is depicted in column 540 of rows 495, 490, 475 and 470 respectively.

Data transfer 950 retrieves the corresponding data (in the second language “Chinese”) from reference database 978 and imports/inserts the data in the second database (master database 975) of the second control system in step 1080. The imported information may be displayed to a user using an interface depicted in FIG. 12.

It should be appreciated that the various features described above can be implemented in various embodiments as a desired combination of one or more of hardware, software and firmware. The description is continued with respect to an embodiment in which various features are operative when software instructions are executed.

V. Digital Processing System

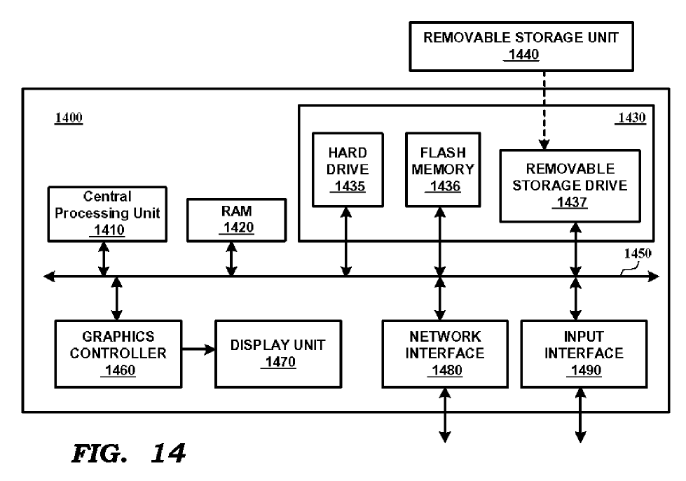

FIG. 14 is a block diagram illustrating the details of digital processing system 1400 in which various aspects of the present invention are operative by execution of appropriate software instructions. Digital processing system 1400 may contain one or more processors such as central processing unit (CPU) 1410, random access memory (RAM) 1420, secondary memory 1430, graphics controller 1460, display unit 1470, network interface 1480, and input interface 1490. All the components except display unit 1470 may communicate with each other over communication path 1450, which may contain several buses as is well known in the relevant arts. The components of FIG. 14 are described below in further detail.

CPU 1410 may execute instructions stored in RAM 1420 to provide several features of the present invention. CPU 1410 may contain multiple processing units, with each processing unit potentially being designed for a specific task. Alternatively, CPU 1410 may contain only a single general purpose, processing unit. RAM 1420 may receive instructions from secondary memory 1430 using communication path 1450.

Graphics controller 1460 generates display signals (e.g., in RGB format) to display unit 1470 based on data/instructions received from CPU 1410. Display unit 1470 contains a display screen to display the images defined by the display signals. Input interface 1490 may correspond to a key-board and/or mouse. Network interface 1480 provides connectivity to a network (e.g., using Internet Protocol), and may be used to communicate with the other systems of FIG. 1.

Secondary memory 1430 may contain hard drive 1435, flash memory 1436, and removable storage drive 1437. Secondary memory 1430 may store the data and software instructions, which enable digital processing system 1400 to provide several features in accordance with the present invention. Some or all of the data and instructions may be provided on removable storage unit 1440, and the data and instructions may be read and provided by removable storage drive 1437 to CPU 1410. Floppy drive, magnetic tape drive, CD-ROM drive, DVD Drive, Flash memory, removable memory chip (PCMCIA Card, EPROM) are examples of such removable storage drive 1437.

Removable storage unit 1440 may be implemented using medium and storage format compatible with removable storage drive 1437 such that removable storage drive 1437 can read the data and instructions. Thus, removable storage unit 1440 includes a computer readable storage medium having stored therein computer software and/or data.

In this document, the term “computer program product” is used to generally refer to removable storage unit 1440 or hard disk installed in hard drive 1435. These computer program products are means for providing software to digital processing system 1400. CPU 1410 may retrieve the software instructions, and execute the instructions to provide various features of the present invention described above.

VI. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system.

What is claimed is:

1. A method of supporting a plurality of languages in a control system to control an environment, said method comprising:
maintaining a reference database containing data of interest in each of said plurality of languages;
returning data in a first language from a master database in response to a plurality of commands received from a user, wherein said master database stores data in said first language;
receiving a command to switch to a second language;
copying said data of interest in said second language from said reference database to said master database; and
returning data in said second language from said master database in response to a second plurality of commands received from said user.

2. The method of claim 1, wherein said maintaining comprises:
extracting said data of interest from said master database in said first language;
translating said data of interest from said first language to said second language; and
updating said reference database with said data of interest in said first language and corresponding data in said second language.

3. The method of claim 2, wherein said translating comprises:
receiving from said user a map of each of a plurality of elements in said first language to corresponding plurality of elements in said second language; and
mapping each element in said data of interest in said first language to the corresponding element in said second language according to said map.

4. The method of claim 1, further comprising:
storing an indication data in a common location, wherein said indication data indicates that said command has requested switch to said second language,
wherein a plurality of applications in said control system examine said common location to determine the specific one of said plurality of languages to operate in.

5. The method of claim 4, wherein said common location comprises a location contained in a database.

6. A method of exporting a data of interest from a first master database containing data in a first language and importing to a second master database containing data in a second language, wherein a first control system operates from said first master database and a second control system operates from said second master database, said method comprising:
maintaining a reference database containing said data of interest in each of a plurality of languages including said first language and said second language;
extracting said data of interest from said first master database;
examining said reference database to determine data in said second language corresponding to said data of interest; and
inserting said data in said second language in said second master database.

7. The method of claim 6, wherein said data of interest is contained in a control strategy used by said first control system and said second control system to respectively control the operation of a first environment and a second environment.

8. The method of claim 7, wherein said reference database is comprised in said second control system.

9. A computer readable medium carrying one or more sequences of instructions for causing a system to support a plurality of languages in a control system to control an environment, wherein execution of said one or more sequences of instructions by one or more processors contained in said system causes said one or more processors to perform the actions of:
maintaining a reference database containing data of interest in each of said plurality of languages;
returning data in a first language from a master database in response to a plurality of commands received from a user, wherein said master database stores data in said first language;
receiving a command to switch to a second language;
copying said data of interest in said second language from said reference database to said master database; and
returning data in said second language from said master database in response to a second plurality of commands received from said user.

10. The computer readable medium of claim 9, wherein said maintaining comprises:
extracting said data of interest from said master database in said first language;
translating said data of interest from said first language to said second language; and
updating said reference database with said data of interest in said first language and corresponding data in said second language.

11. The computer readable medium of claim 10, wherein said translating comprises:
receiving from said user a map of each of a plurality of elements in said first language to corresponding plurality of elements in said second language; and
mapping each element in said data of interest in said first language to the corresponding element in said second language according to said map.

12. The computer readable medium of claim 9, further comprising: storing an indication data in a common location, wherein said indication data indicates that
said command has requested switch to said second language,
wherein a plurality of applications in said control system examine said common location to determine the specific one of said plurality of languages to operate in.

13. The computer readable medium of claim 12, wherein said common location comprises a location contained in a database.

14. A computer readable medium carrying one or more sequences of instructions for causing a system to export a data of interest from a first master database containing data in a first language and import to a second master database containing data in a second language, wherein a first control system operates from said first master database and a second control system operates from said second master database, wherein execution of said one or more sequences of instructions by one or more processors contained in said system causes said one or more processors to perform the actions of:
maintaining a reference database containing said data of interest in each of a plurality of languages including said first language and said second language;
extracting said data of interest from said first master database;
examining said reference database to determine data in said second language corresponding to said data of interest; and
inserting said data in said second language in said second master database.

15. The computer readable medium of claim 14, wherein said data of interest is contained in a control strategy used by said first control system and said second control system to respectively control the operation of a first environment and a second environment.

16. The computer readable medium of claim 15, wherein said reference database is comprised in said second control system.

17. A system of supporting a plurality of languages in a control system to control an environment, said system comprising:
means for maintaining a reference database containing data of interest in each of said plurality of languages;
means for returning data in a first language from a master database in response to a plurality of commands received from a user, wherein said master database stores data in said first language;
means for receiving a command to switch to a second language;
means for copying said data of interest in said second language from said reference database to said master database; and
means for returning data in said second language from said master database in response to a second plurality of commands received from said user.

18. The system of claim 17, wherein said means for maintaining comprises:
means for extracting said data of interest from said master database in said first language;
means for translating said data of interest from said first language to said second language; and
means for updating said reference database with said data of interest in said first language and corresponding data in said second language.

19. The system of claim 18, wherein said means for translating comprises:
means for receiving from said user a map of each of a plurality of elements in said first language to corresponding plurality of elements in said second language; and
means for mapping each element in said data of interest in said first language to the corresponding element in said second language according to said map.

20. The system of claim 17, further comprising:
means for storing an indication data in a common location, wherein said indication data indicates that said command has requested switch to said second language,
wherein a plurality of applications in said control system examine said common location to determine the specific one of said plurality of languages to operate in.

21. The system of claim 20, wherein said common location comprises a location contained in a database.

22. A system of exporting a data of interest from a first master database containing data in a first language and importing to a second master database containing data in a second language, wherein a first control system operates from said first master database and a second control system operates from said second master database, said system comprising:
means for maintaining a reference database containing said data of interest in each of a plurality of languages including said first language and said second language;
means for extracting said data of interest from said first master database;
means for examining said reference database to determine data in said second language corresponding to said data of interest; and
means for inserting said data in said second language in said second master database.

23. The system of claim 22, wherein said data of interest is contained in a control strategy used by said first control system and said second control system to respectively control the operation of a first environment and a second environment.

24. The system of claim 23, wherein said reference database is comprised in said second control system.
